(19) United States
(12) Patent Application Publication
(10) Pub. No.: US 2026/0212695 A1
(43) Pub. Date: Jul. 23, 2026

(54) METHOD AND DEVICE FOR RECONSTRUCTING A PANORAMIC IMAGE OF A FINGERPRINT

(71) Applicant: IDEMIA PUBLIC SECURITY FRANCE, Courbevoie (FR)

(72) Inventors: Emilie NIAF, Courbevoie (FR); Victor VIDEAU, Courbevoie (FR); Laurent KAZDAGHLI, Courbevoie (FR)

(73) Assignee: IDEMIA PUBLIC SECURITY FRANCE, Courbevoie (FR)

(21) Appl. No.: 19/359,184

(22) Filed: Oct. 15, 2025

(30) Foreign Application Priority Data
Jan. 23, 2025 (FR) FR2500689

(51) Int. Cl. G06V 40/12; G06T 7/33; G06V 40/13

(52) U.S. Cl. CPC G06V 40/1335; G06T 7/337; G06V 40/1312; G06V 40/1353; G06T 2207/30196

(57) ABSTRACT

A method, implemented by a data processing device, for reconstructing a panoramic image of a fingerprint from at least two images of a finger which are acquired at different viewing angles, the method including determining common minutiae between the two images, determining a global geometric transformation so as to link the common minutiae between the images by minimizing a residual error between the positions of said common minutiae between the images, selecting the common minutiae for which the residual error is less than a given threshold value, determining, from the global geometric transformation, a modified global geometric transformation so as to link only the selected common minutiae; Determining, for each image, a demarcation line passing through the areas of the image exhibiting the highest density of selected common minutiae, and joining the images along the demarcation line by applying the modified global geometric transformation to form a panoramic image.

### TECHNICAL FIELD

The present invention relates to a method and a device for reconstructing a panoramic image of a fingerprint.

### TECHNICAL BACKGROUND

Dactyloscopy is a method for identifying individuals based on the use of dactylograms, also known as “papillary prints” comprising “fingerprints” and “palm prints”. This method is notably used by criminal records services or by civil identification systems, for example, during administrative procedures, at border crossings or for access to secure premises.

Dactylograms are patterns formed by the traces left on surfaces by the dermatoglyphs of fingers and/or palms of hands. Dermatoglyphs are the surface furrows formed on palms, soles and finger pads by friction ridges and arranged in lines or whorls. They are unique to each individual. The patterns thereof form an anthropometric “identity card” for each individual, by which individuals can be identified.

The acquisition of a fingerprint commonly takes place using an optical device capable of acquiring a resolved image of dermatoglyphs. It is possible to distinguish between contact-based acquisition devices for which one or more fingers are placed on an acquisition surface (Maillard, Poitelon and Dumont 2022; Trouboul 2020), and contactless acquisition devices for which one or more fingers are placed in the field of vision of one or more optical apparatuses (Fourre et al. 2009; Fourre, Beaudet and Sireta 2022; Bezot et al. 2024).

One of the main benefits of contact-based acquisition devices is the possibility of acquiring complete fingerprints comprising the patterns of the dermatoglyphs from both edges of the fingers. These fingerprints, referred to as “rolled fingerprints”, are obtained by making each finger roll on the acquisition surface, from one edge of the fingernail to the other about its longitudinal axis. Although their acquisition requires time and some precision, these types of fingerprints generally act as benchmarks due to their completeness.

Due to their better ergonomics, simplicity of use and the possibility of acquiring fingerprints of several fingers simultaneously, contactless acquisition devices are more commonly used. They are used to acquire fingerprints referred to as “plain”, substantially comprising the pattern of dermatoglyphs of the central region of the pad of the distal phalanx of the fingers. However, a major drawback of these contactless acquisition devices is the difficulty in obtaining “rolled” fingerprints with a resolution that is sufficient in particular to compare them with fingerprints in a database of reference “rolled” fingerprints during, for example, an identification operation by a court.

Methods exist for reconstructing a fingerprint by mosaicing several partial images.

A first method consists in extracting a set of minutiae of each of two images, identifying matching minutiae between the sets of minutiae, determining conversion parameters based on the matching minutiae, transposing the minutiae of the two images into the same reference system using the conversion parameters, overlapping the two sets based on the transposed minutiae (Russo 2003).

A second method consists in extracting the minutiae points of the two images, calculating the orientation of minutiae points, adding simulated points as a function of the orientation of the minutiae points, registering the set of minutiae points using the ICP (Iterative Closest Point) algorithm and, lastly, combining the minutiae points into a fingerprint template (Rahmes, Mayron and Allen 2010).

A third method consists in extracting minutiae from each partial image, calculating a descriptor vector for each minutia, evaluating an association score based on the minutiae and on their descriptor vectors, and assembling the image parts for which the association score is the highest (Niaf and Girard 2020).

However, these methods are not suitable for obtaining rolled fingerprints from several images obtained by a contactless acquisition device.

### SUMMARY OF THE INVENTION

A first aspect of the invention relates to a method, implemented by a data processing device, for reconstructing a panoramic image of a fingerprint from at least two images of a finger which are acquired at different viewing angles, the method comprising the following steps:
(a) Determining common minutiae between the two images;
(b) Determining a global geometric transformation so as to link the common minutiae between the images by minimizing a residual error between the positions of said common minutiae between the images;
(c) Selecting the common minutiae for which the residual error is less than a given threshold value;
(d) Determining, from the global geometric transformation, a modified global geometric transformation so as to link only the selected common minutiae;
(e) Determining, for each image, a demarcation line passing through the areas of the image exhibiting the highest density of selected common minutiae;
(f) Joining the images along the demarcation line by applying the modified global geometric transformation to form a panoramic image.

According to certain embodiments, the step for the modified global geometric transformation comprises a substep for calculating a local heatmap of the selected common minutiae for each image, and the demarcation line passes through the maxima of the local heatmap.

According to certain embodiments, the demarcation line extends in the direction of the longitudinal axis of the finger.

According to certain embodiments, the viewing angles of the images are defined with respect to the longitudinal axis of the finger.

According to certain embodiments, the threshold value is defined by the quadratic sum of the residual errors between the positions of the common minutiae linked between the images during the step for determining the global geometric transformation.

A second aspect of the invention relates to a data processing device comprising means for implementing a method for reconstructing a panoramic image of a fingerprint according to any one of the embodiments of the first aspect of the invention.

A third aspect of the invention relates to a computer program comprising instructions which, when they are executed by a data processing device, drive said device to implement a method for reconstructing a panoramic image of a fingerprint according to any one of the embodiments of the first aspect of the invention.

A fourth aspect of the invention relates to a method for acquiring a panoramic image of a fingerprint of a finger, the method comprising:
the acquiring of at least two images of a fingerprint of a finger at different viewing angles;
the constructing of a panoramic image of a fingerprint using a method for reconstructing a panoramic image of a fingerprint according to any one of the embodiments of the first aspect of the invention.

A fifth aspect of the invention relates to a fingerprint acquisition system comprising:
a fingerprint acquisition device, preferably contactless, configured to acquire at least two images of a finger at different viewing angles;
a data processing device according to the second aspect of the invention.

### BRIEF DESCRIPTION OF THE DRAWINGS

FIG. 1 is a schematic representation of a contactless fingerprint acquisition system.

FIG. 2 is a schematic representation of a data processing device.

FIG. 3 is a schematic representation of a finger of a hand.

FIG. 4 is a schematic representation of two images of a fingerprint acquired at different viewing angles using an acquisition system such as that of FIG. 1.

FIG. 5 is a flowchart of a method for reconstructing a panoramic image of a fingerprint according to the first aspect of the invention.

FIG. 6 is a schematic representation of the determining of common minutiae between two images of a fingerprint and of their linking by a global geometric transformation.

FIG. 7 is a schematic representation of the selecting of common minutiae between two images of a fingerprint and of their linking by a modified global geometric transformation.

FIG. 8 is a schematic representation of a demarcation line passing through the areas of two images of a fingerprint exhibiting the highest density of selected common minutiae.

FIG. 9 is a schematic representation of the joining of two images of a fingerprint along a demarcation line.

### DETAILED DESCRIPTION OF EMBODIMENTS

Within the scope of the present disclosure, the embodiments are described in the general context of one or more items of equipment, devices or systems capable of executing preloaded instructions such as, for example, instructions that can be executed by computer for the execution of program modules. The program modules can comprise one or more routines, programs, objects, variables, commands, scripts, functions, applications, components and data structures which can execute particular tasks or implement particular abstract data types.

Certain embodiments can also be implemented in distributed computing environments in which tasks are executed by remote data processing devices which are connected by a communication network. In a distributed computing environment, the program modules can be on local and/or remote computing storage media, including memory storage devices.

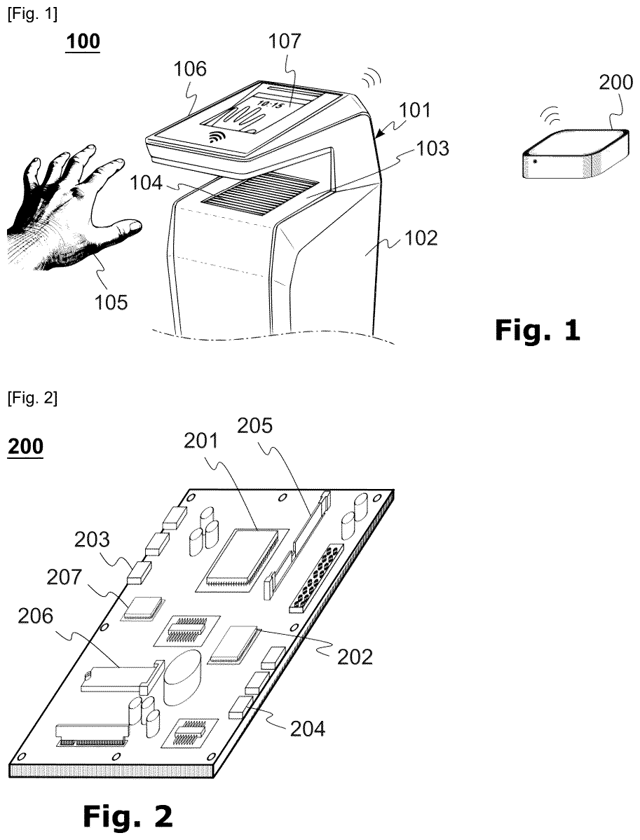

With reference to FIG. 1, a contactless fingerprint acquisition system 100 generally comprises a contactless fingerprint image acquisition device 101 and a data processing device 200 configured to receive and process the images acquired by the acquisition device 101.

According to an illustrative example (Fourre, Beaudet and Sireta 2022), the contactless acquisition device 101 comprises a box 102, the upper face 103 of which is equipped with an acquisition surface 104. When an individual (not represented) positions their hand 105 above the acquisition surface 104, the device 101 proceeds with the acquisition of fingerprints of the fingers of said hand 105. Two acquisition modes are possible. In the static acquisition mode, the hand 105 is placed above the acquisition surface 104 such that it is kept very still for a few seconds. In the dynamic mode, the hand 105 is moved laterally above the acquisition surface 104 in a “sweeping” movement.

The acquisition device 101 can additionally comprise a platform 106 above the acquisition surface 104. The platform 106 is positioned at a certain distance from the acquisition surface 104 so as to form an opening which opens out to the front and sides to facilitate and guide the movement of the hand 105 of the individual 105 above said surface 104. The purpose of the platform 106 is to reduce the quantity of external light capable of penetrating said surface 104 and to thus improve the contrast in the acquired fingerprints. The platform 106 can be equipped with a man-machine interface in the form of a display device 107, possibly touch-sensitive, for displaying user instructions for the individual and/or to convey notifications to the individual.

In the box 102, under the acquisition surface 104, a light source (not represented) provides for illuminating the passing hand 105 of the individual, and a videographic or photographic device (not represented) provides for acquiring one or more fingerprints by the collection of light reflected by the fingers of the hand 105. Whether the acquisition is static or dynamic, the videographic or photographic device is configured to acquire the fingerprints at different viewing angles for reasons of completeness.

With reference to FIG. 2, the data processing device 200 is responsible for automatically executing sequences of arithmetic or logic operations to carry out tasks or actions. This device, commonly referred to as a computer, can comprise one or more central processing units (CPUs) 201 and/or one or more graphics processing units (GPUs) 202, a physical module 203 for remote communication, one or more input/output physical modules 204 for exchanging data with external devices, a transitory storage medium 205 such as a random access memory (RAM), a non-transitory recording medium 206, and communication buses (not represented) for transferring data between the internal components of the device. It can also comprise a secure item 207 for storing cryptographic keys, executing encryption algorithms, and/or storing and/or encrypting any other algorithm and/or data for which security and confidentiality must be preserved.

The data processing device 200 provides for the execution of one or more programs or program modules containing instructions which, when the program module or modules are executed, drive said data processing device 200 to implement the processing of the images acquired by the acquisition device 200. The program module or modules can be written in any programming language, compiled or interpreted. They can form part of a software solution, i.e. a collection of executable instructions, codes, scripts etc. and/or databases.

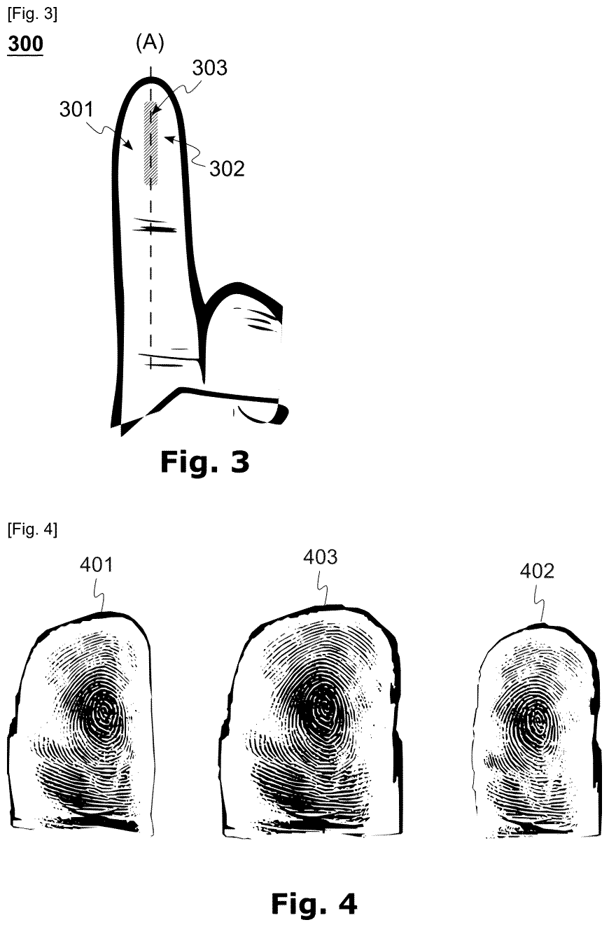

With reference to FIG. 3, a finger 300 of a hand has a substantially cylindrical shape about its longitudinal axis (A). From the point of view of the individual, a distinction can be drawn between a righthand part 301 extending approximately from the central region 303 of the pad of the distal phalanx to the righthand edge of the fingernail, and a lefthand part 302 extending approximately from the central region 303 of the pad of the distal phalanx to the lefthand edge of the fingernail. When the fingerprint is acquired, the part 301, 302 of the finger that is closest to the acquisition surface 104 of the acquisition device 101 and/or located in the optical axis of the videographic or photographic device underneath will appear more distinctly than the other.

This perspective effect manifests in particular by a larger representation of the fingerprint by the part of the finger 301, 302 closest to the acquisition surface 104 of the acquisition device 101 and/or to the optical axis of the videographic or photographic device underneath, and by a narrowing of the width of the furrows in the area of the fingerprint corresponding to the part of the finger 301, 302 that is the furthest away. By way of example, with reference to FIG. 4, for a contactless acquisition device 101 configured to acquire images of a fingerprint of a finger from at least two different viewing angles, it can obtain two images 401, 402 of a fingerprint, each representing respectively and in a majority sense the lefthand part 302 and the righthand part 301 of a finger 300. Preferably, the viewing angles of the images 401, 402 are defined with respect to the longitudinal axis (A) of the finger 300.

In FIG. 4, the central image 403 is a panoramic image of the fingerprint of the finger reconstructed from the two images 401, 402 of the finger 300 which are acquired at different viewing angles. This image 403 is equivalent to the image of a rolled fingerprint as can be obtained with a contact-based acquisition device. It is obtained using a reconstruction method according to the first aspect of the invention.

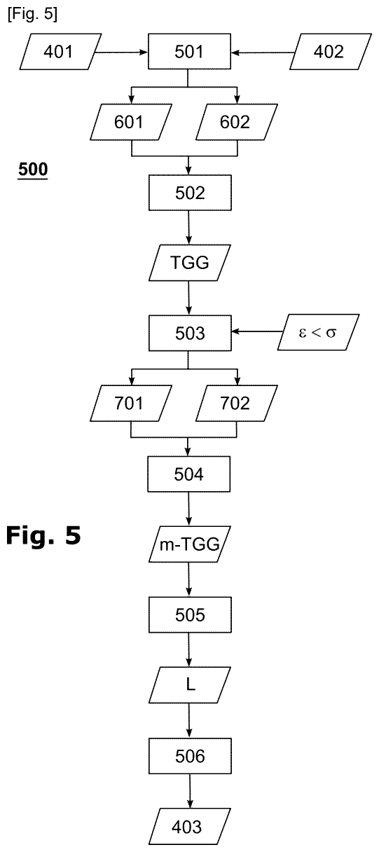

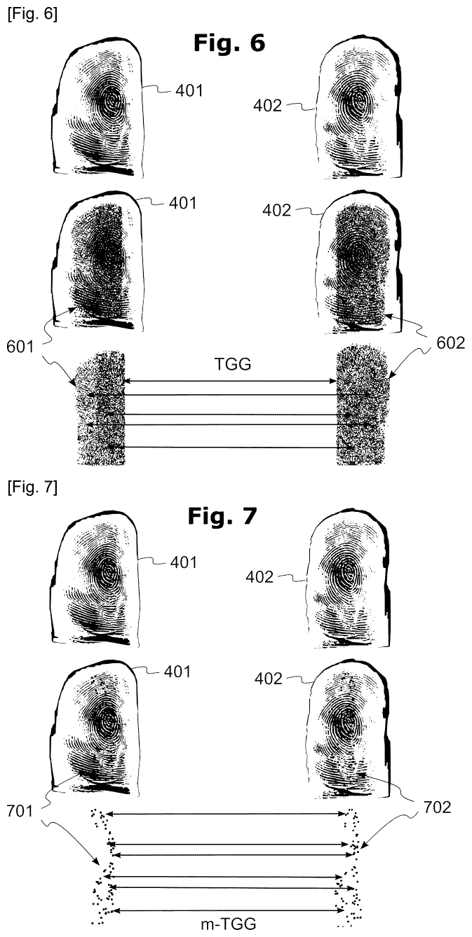

With reference to FIG. 5-9, the first aspect of the invention relates to a method 500, implemented by a data processing device 200, for reconstructing a panoramic image 403 of a fingerprint from at least two images 401, 402 of a finger 300 which are acquired at different viewing angles. The method 500 comprises the following steps:
(a) Determining 501 common minutiae 601, 602 between the two images 401, 402;
(b) Determining 502 a global geometric transformation TGG so as to link the common minutiae 601, 602 between the images 401, 402 by minimizing a residual error ε between the positions of said common minutiae 601, 602 between the images 401, 402;
(c) Selecting 503 the common minutiae 701, 702 for which the residual error ε is less than a given threshold value σ;
(d) Determining 504, from the global geometric transformation TGG, a modified global geometric transformation m-TGG so as to link only the selected common minutiae 701, 702;
(e) Determining 505, for each image 401, 402, a demarcation line L passing through the areas of the image exhibiting the highest density of selected common minutiae 701, 702;
(f) Joining 506 the images along the demarcation line L by applying the modified global geometric transformation m-TGG to form a panoramic image 403.

At step 501, common minutiae 601, 602 between the two images 401, 402 can be determined using any suitable method. Examples of algorithms include descriptor/detector algorithms such as SIFT (Lowe 1999), SURF (Bay, Tuytelaars and Van Gool 2006), BRIEF and ORB (Karami, Prasad and Shehata 2017; Ma et al. 2021), or neural network algorithms such as Siamese neural networks (Hanif 2019).

According to the method used for determining common minutiae 601, 602, it is possible for certain minutiae between the two images 401, 402 to be paired without furrows and/or ridges of the fingerprint being picked up. This is particularly the case for the points at the edges of the images 401, 402 of the fingerprint, and corresponding to the extreme edges of the fingers. These points, referred to as “edge points”, can exhibit similarities only because they are located at the sides of the fingers, without association with the furrows and/or ridges of the fingerprint. They can therefore advantageously be suppressed.

At step 502, a global geometric transformation TGG is determined so as to link the common minutiae 601, 602 between the images 401, 402. For example, this involves determining the global geometric transformation TGG for linking the common minutiae 601 of the image 401 with the corresponding common minutiae 602 of the image 402 based on, for example, a matching score calculated between the descriptor vectors of these points 601, 602 when they are determined using a descriptor/detector algorithm as described previously. In other words, the global geometric transformation TGG is such that it minimizes the matching scores between the descriptor vectors of the common minutiae 601, 602 between the images 401, 402; this is equivalent to minimizing a residual error ε between the positions of said common minutiae 601, 602. The global geometric transformation TGG can hence notably be a rotation, a translation and/or a dilation.

The linking of the common minutiae 601, 602 between the images 401, 402 can be achieved using any suitable methods such as point-wise matching methods (J. Chen and Moon 2008; Park, Pankanti and Jain 2008), RANdom SAmple Consensus algorithms (Fischler and Bolles 1981), Iterative Closest Point algorithm (Y. Chen and Medioni 1992; Zhang 1994) or Thin-Plate Splines (Donato and Belongie 2002).

With reference to FIG. 7, step 503 consists in selecting the common minutiae 701, 702 for which the residual error ε is less than a given threshold value σ; in other words, to eliminate the common minutiae 601, 602 for which matching is uncertain. These “uncertain” points are likely to form artifacts during the reconstruction of the panoramic image of a fingerprint. A threshold value σ for the residual error ε is defined beforehand; only the common minutiae 701, 702, from among the set of common minutiae 601, 602 between the images 401, 402, for which the residual error ε is less than the threshold value σ, are preserved. A threshold value σ can vary according to the resolution of the images 401, 402 and the desired precision for the reconstruction.

According to certain embodiments, the threshold value σ is defined by the quadratic sum of the residual errors between the positions of the common minutiae 601, 602 linked between the images 401, 402 during step 502. This sum can be affected by a sensitivity coefficient, the value of which is between 0.5 and 1.

This definition of the threshold value σ can be expressed by the following relationship:

$$σ = α \sum {( ε ( {p}_{i} , {q}_{i} ) )}^{2}$$

where ε(pᵢ, qᵢ) is the residual error between the common minutiae pᵢ,qᵢ linked between the two images 401, 402, and a is a sensitivity coefficient defined to be between 1 and 0.5.

Once the common minutiae 701, 702 are selected, a modified global geometric transformation m-TGG is determined from the global geometric transformation TGG so as to link only the selected common minutiae 701, 702 between the images 401, 402. In other words, the global geometric transformation TGG is recalculated, as determined at step 502, but based only on the selected common minutiae 701, 702. This modified global geometric transformation m-TGG is more accurate than the original global geometric transformation TGG.

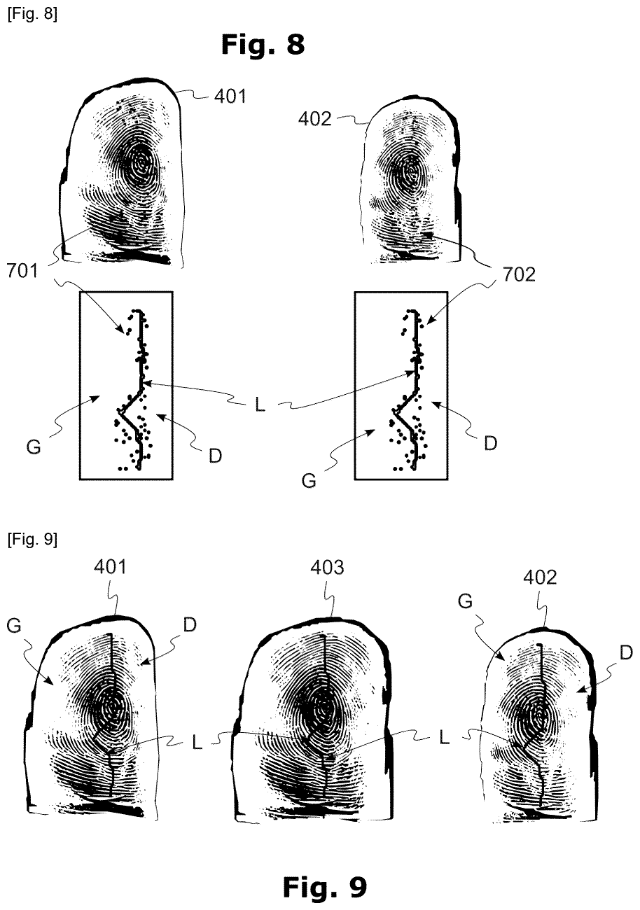

At step 504, with reference to FIG. 8, for each image 401, 402, a demarcation line L is determined. This demarcation line L passes through the areas of the image 401, 402 exhibiting the highest density of selected common minutiae 701, 702. Due to the similarities of the selected common minutiae 701, 702, the position of the demarcation line L on each image 401, 402 is substantially identical. The fingerprint represented on each image 401, 402 is divided into a lefthand part (G) and a righthand part (D) by the demarcation line L. Preferably, the demarcation line L extends in the direction of the longitudinal axis (A) of the finger 300.

According to certain embodiments, step 504 comprises a substep 504e for calculating a local heatmap of the selected common minutiae 701, 702 of each image 401, 402, the demarcation line L passing through the maxima of the local heatmap.

The local heatmap of selected common minutiae can be calculated using any suitable method such as a Kernel Density Estimator (Parzen 1962; Silverman 2018) or a Kernel Filter. An example kernel filter which can typically be used for images 401, 402 at 500 dpi is a 9×9 normalized summation matrix.

The local heatmaps provide a representation of the areas with the highest densities of selected common minutiae, enabling maxima points to be located. These maxima points serve to define a path for a demarcation line L along the longitudinal axis (A) of the finger 300.

At step 506, with reference to FIG. 9, the images 401, 402 are joined along the demarcation line L by the application of the modified global geometric transformation m-TGG at step 504. In FIG. 9, the joining of the images 401, 402 has the effect of suppressing the righthand part (D) of the image 401 and the lefthand part (G) of the image 402 to form a reconstructed image 403.

The method according to the first aspect of the invention is implemented by computer. With reference to FIG. 2, a second aspect of the invention relates to a data processing device 200 comprising means for implementing a method 500 for reconstructing a panoramic image 403 of a fingerprint according to any one of the embodiments of the first aspect of the invention.

The data processing device 200 can be integrated in the acquisition device 101 or be an add-on device in communication with said acquisition device 101 in a distributed or non-distributed computing environment.

A third aspect of the invention relates to a computer program or computer program module containing instructions which, when they are executed by a data processing device 200, drive said device to implement a method 500 for reconstructing a panoramic image 403 of a fingerprint according to any one of the embodiments of the first aspect of the invention. The program can be written in any programming language, compiled or interpreted. They can form part of a software solution, i.e. a collection of executable instructions, codes, scripts etc. and/or databases.

A fourth aspect of the invention relates to a method for acquiring a panoramic image 403 of a fingerprint of a finger 300. The method comprises:
the acquiring of at least two images 401, 402 of a fingerprint of a finger 300 at different viewing angles;
the constructing of a panoramic image 403 of a fingerprint using a method 500 for reconstructing a panoramic image 403 of a fingerprint according to any one of the embodiments of the first aspect of the invention.

To this end, the fourth aspect of the invention relates to a fingerprint acquisition system 100 comprising:
a fingerprint acquisition device 101, preferably contactless, configured to acquire at least two images 401, 402 of a finger 300 at different viewing angles;
a data processing device 200 according to the second aspect of the invention.

### REFERENCES

Bay, Herbert, Tinne Tuytelaars and Luc Van Gool. 2006. “SURF: Speeded up Robust Features”. In Lecture Notes in Computer Science, 404-17. Lecture Notes in Computer Science. Berlin, Heidelberg: Springer Berlin Heidelberg.
Bezot, Grégoire, Elise Le Gouil, Marine Peschaux, Joël-Yann Fourre and Mokrane Malek. 2024. Dispositif de capture d'empreinte biométrique sans contact [Non-contact biometric fingerprint capturing device]. EPO 4 303 837 A1. European Patent Application, filed May 2, 2023, and issued Jan. 10, 2024. https://patents.google.com/patent/EP4303837A1/fr?oq=EP+4303837A1+.
Chen, Jiansheng and Yiu-Sang Moon. 2008. “Using SIFT features in palmprint authentication”. In 2008 19th International Conference on Pattern Recognition, 1-4. IEEE.
Chen, Yang and Gerard Medioni. 1992. “Object Modelling by Registration of Multiple Range Images”. Image and Vision Computing 10 (3): 145-55.
Donato, Gianluca and Serge Belongie. 2002. “Approximate thin plate spline mappings”. In Computer Vision—ECCV 2002, 21-31. Lecture notes in computer science. Berlin, Heidelberg: Springer Berlin Heidelberg.
Fischler, Martin A. and Robert C. Bolles. 1981. “Random Sample Consensus: A Paradigm for Model Fitting with Applications to Image Analysis and Automated Cartography”. Communications of the ACM 24 (6): 381-95.
Fourre, Joël-Yann, Jean Beaudet and Alexis Sireta. 2022. Capteur et procédé d'acquisition biométrique sans contact [Contactless biometric sensor and acquisition method]. WIPO 2022253587A1. World Patent Application, filed May 19, 2022, and issued Dec. 8, 2022.
Fourre, Joël-Yann, Sylvaine Picard, François Rieul and Jean-Christophe Fondeur. 2009. Dispositif d'acquisition d'empreintes digitales à la volée [Device for acquiring fingerprints on the fly]. WIPO 2009112717:A1. World Patent, filed Feb. 12, 2009 and issued Sep. 17, 2009.
Hanif, Muhammad Shehzad. 2019. “Patch Match Networks: Improved Two-Channel and Siamese Networks for Image Patch Matching”. Pattern Recognition Letters 120 (April): 54-61.
Karami, Ebrahim, Siva Prasad and Mohamed Shehata. 2017. “Image matching using SIFT, SURF, BRIEF and ORB: Performance comparison for distorted images”. arXiv [cs.CV].
Lowe, D. G. 1999. “Object recognition from local scale-invariant features”. In Proceedings of the Seventh IEEE International Conference on Computer Vision, 2:1150-57 vol. 2. IEEE.
Ma, Jiayi, Xingyu Jiang, Aoxiang Fan, Junjun Jiang and Junchi Yan. 2021. “Image Matching from Handcrafted to Deep Features: A Survey”. International Journal of Computer Vision 129 (1): 23-79.
Maillard, Sylvain, Olivier Poitelon and Denis Dumont. 2022. Dispositif de capture biométrique [Biometric capture device]. EPO 4 105 897 A1. European Patent Application, filed May 11, 2022, and issued Dec. 21, 2022.
Niaf, Emilie and Fantin Girard. 2020. Procédé de reconstruction d'une image d'empreinte à partir de parties d'image [Method for reconstructing an imprint image from image portions]. EPO 3 621 026 A1. European Patent Application, filed Aug. 29, 2019, and issued Mar. 11, 2020.
Park, Unsang, Sharath Pankanti and A. K. Jain. 2008. “Fingerprint verification using SIFT features”. In Biometric Technology for Human Identification V, published by B. V. K. Vijaya Kumar, Salil Prabhakar and Arun A. Ross. SPIE.
Parzen, E. 1962. “On estimation of a probability density function and mode”. Annals of Mathematical Statistics 33 (3): 1065-76.
Rahmes, Mark, Liam M. Mayron and Josef Allen. 2010. Procédé de synthèse de modèles d'empreintes digitales et presentation des empreintes digitales en mosaïques au moyen d'un algorithme de mise en correspondance de points [A method for fingerprint template synthesis and fingerprint mosaicing using a point matching algorithm]. WIPO 2010104885A1. World Patent Application, filed Mar. 9, 2010, and issued Sep. 16, 2010.
Russo, Anthony P. 2003. Method for combining fingerprint templates representing various sensed areas of a fingerprint to derive one fingerprint template representing the fingerprint. U.S. Pat. No. 6,546,122. US Patent, filed Jul. 29, 1999, and issued Apr. 8, 2003.
Silverman, B. W. 2018. Density estimation for statistics and data analysis. Routledge.
Trouboul, Laurent. 2020. Capteur d'empreintes papillaires à lame mince [Thin sheet papillary print sensor]. INPI FR3095535A1. French Patent Application, filed Apr. 25, 2019, and issued Oct. 30, 2020.
Zhang, Zhengyou. 1994. “Iterative Point Matching for Registration of Free-Form Curves and Surfaces”. International Journal of Computer Vision 13 (2): 119-52.

1. A method, implemented by a data processing device, for reconstructing a panoramic image of a fingerprint from at least two images of a finger which are acquired at different viewing angles, the method comprising:
(a) Determining common minutiae between the two images;
(b) Determining a global geometric transformation to link the common minutiae between the images by minimizing a residual error between positions of said common minutiae between the images;
(c) Selecting the common minutiae for which the residual error is less than a given threshold value;
(d) Determining, from the global geometric transformation, a modified global geometric transformation to link only the selected common minutiae;
(e) Determining, for each image, a demarcation line passing through areas of the image exhibiting the highest density of selected common minutiae; and
(f) Joining the images along the demarcation line by applying the modified global geometric transformation to form a panoramic image.

2. The method as claimed in claim 1, wherein the determining the modified global geometric transformation includes a substep for calculating a local heatmap of the selected common minutiae for each image, and the demarcation line passes through the maxima of the local heatmap.

3. The method as claimed in claim 1, wherein the demarcation line extends in a direction of a longitudinal axis of the finger.

4. The method as claimed in claim 1, wherein the viewing angles of the images are defined with respect to a longitudinal axis of the finger.

5. The method as claimed in claim 1, wherein the threshold value is defined by a quadratic sum of the residual errors between the positions of the common minutiae linked between the images during the determining the global geometric transformation.

6. A data processing device for reconstructing a panoramic image of a fingerprint from at least two images of a finger which are acquired at different viewing angles comprising:
processing circuitry configured to:
determine common minutiae between the two images,
determine a global geometric transformation to link the common minutiae between the images by minimizing a residual error between positions of said common minutiae between the images,
select the common minutiae for which the residual error is less than a given threshold value,
determine, from the global geometric transformation, a modified global geometric transformation to link only the selected common minutiae,
determine, for each image, a demarcation line passing through areas of the image exhibiting the highest density of selected common minutiae, and
join the images along the demarcation line by applying the modified global geometric transformation to form a panoramic image.

7. A non-transitory computer readable medium having stored thereon a computer program having instructions which, when they are executed by a data processing device, drive said device to implement the method for reconstructing the panoramic image of the fingerprint as claimed in claim 1.

8. A method for acquiring a panoramic image of a fingerprint of a finger, the method comprising:
acquiring of at least two images of a fingerprint of a finger at different viewing angles; and
constructing of a panoramic image of a fingerprint by reconstructing the panoramic image of the fingerprint as claimed in claim 1.

9. A fingerprint acquisition system, comprising:
a fingerprint acquisition device configured to acquire at least two images of a finger at different viewing angles; and
a data processing device as claimed in claim 6.

10. The fingerprint acquisition system according to claim 9, wherein the fingerprint acquisition device is contactless.

11. The method as claimed in claim 2, wherein the demarcation line extends in a direction of a longitudinal axis of the finger.

12. The method as claimed in claim 2, wherein the viewing angles of the images are defined with respect to a longitudinal axis of the finger.

13. The method as claimed in claim 3, wherein the viewing angles of the images are defined with respect to the longitudinal axis of the finger.

14. The method as claimed in claim 2, wherein the threshold value is defined by a quadratic sum of the residual errors between the positions of the common minutiae linked between the images during the determining the global geometric transformation.

15. The method as claimed in claim 3, wherein the threshold value is defined by a quadratic sum of the residual errors between the positions of the common minutiae linked between the images during the determining the global geometric transformation.

16. The method as claimed in claim 4, wherein the threshold value is defined by a quadratic sum of the residual errors between the positions of the common minutiae linked between the images during the determining the global geometric transformation.

17. A method for acquiring a panoramic image of a fingerprint of a finger, the method comprising:
acquiring of at least two images of a fingerprint of a finger at different viewing angles; and
constructing of a panoramic image of a fingerprint by reconstructing the panoramic image of the fingerprint as claimed in claim 2.

18. A method for acquiring a panoramic image of a fingerprint of a finger, the method comprising:
acquiring of at least two images of a fingerprint of a finger at different viewing angles; and
constructing of a panoramic image of a fingerprint by reconstructing the panoramic image of the fingerprint as claimed in claim 3.

19. A method for acquiring a panoramic image of a fingerprint of a finger, the method comprising:
acquiring of at least two images of a fingerprint of a finger at different viewing angles; and
constructing of a panoramic image of a fingerprint by reconstructing the panoramic image of the fingerprint as claimed in claim 4.

20. A method for acquiring a panoramic image of a fingerprint of a finger, the method comprising:
acquiring of at least two images of a fingerprint of a finger at different viewing angles; and
constructing of a panoramic image of a fingerprint by reconstructing the panoramic image of the fingerprint as claimed in claim 5.
